(19) United States
(12) Patent Application Publication
(10) Pub. No.: US 2026/0364637 A1
(43) Pub. Date: Nov. 19, 2026

(54) Unbalance Exciter with Unbalance-Free Run-up

(71) Applicant: Wacker Neuson Produktion GmbH & Co. KG, Reichertshofen (DE)

(72) Inventor: Ferdinand Rupp, Oberguenzburg (DE)

(21) Appl. No.: 19/673,584

(22) Filed: May 11, 2026

(30) Foreign Application Priority Data
May 16, 2025 (DE) 10 2025 119 031.3

(51) Int. Cl. B06B 1/16; E01C 19/34

(52) U.S. Cl. CPC B06B 1/16; E01C 19/34

(57) ABSTRACT

An unbalance exciter has a rotationally driven exciter shaft having a fixed unbalance mass which is carried by the exciter shaft and which is fixedly connected to the exciter shaft; and having a free unbalance mass which is carried by the exciter shaft and which is rotatable on the exciter shaft. The free unbalance mass is held in a defined initial position by a detent device. Thee free unbalance mass is held in a defined unbalance position by an entrainment device when the free unbalance mass is not held in the initial position by the detent device. The the detent device is designed in such a manner that, when a predetermined switching speed is exceeded, the detent device is released and the free unbalance mass is no longer held in the defined initial position by the detent device. In the initial position, an unbalance effect of the free unbalance mass and an unbalance effect of the fixed unbalance mass are directed at least partially in opposite directions. In the unbalance position, the unbalance effect of the free unbalance mass and the unbalance effect of the fixed unbalance mass are directed at least partially inline with one another.

### BACKGROUND INFORMATION

### 1. Field of the Invention

The invention relates to an unbalance exciter or vibration exciter for use in a vibration plate for soil compaction.

### 2. Background of the Invention

Vibration plates for soil compaction are well known and are also known as vibratory plates, for example. They usually have a ground contact plate that is in contact with the ground to be compacted and is set in vibration by an unbalance exciter or vibration exciter. The vibrations cause the desired compaction of the ground.

Vibration plates can be of different sizes and have different drives, such as combustion motors or electric motors. The unbalance exciters used usually have at least one unbalance shaft or exciter shaft on which an unbalance mass with an eccentric center of gravity is provided. The desired vibration is achieved by rotating the exciter shaft. Known vibration plates have, for example, one exciter shaft or two exciter shafts that rotate in opposite directions. However, vibration plates with more than two exciter shafts are also known.

Vibration plates with only one exciter shaft or a single exciter tend to be smaller machines and are therefore used for compacting smaller surfaces. A typical example of this is the so-called trailing oscillator, in which an exciter shaft is driven by a drive.

Vibration plates with an electric drive train and an electric controller are becoming increasingly popular. The exciter can then be switched on or off using an electrical switch.

One problem with vibration plates with only one exciter shaft is that the exciter shaft runs up from standstill to its operating speed, generating unbalance forces with different frequencies due to the changing speed. The frequencies can sometimes coincide with the resonance frequencies of the vibration plate and thus lead to undesirable strong vibrations in the machine even before the actual compaction operation begins.

In the case of vibration plates with two counter-rotating exciter shafts, however, it is often possible to achieve at least partial compensation of the unbalance forces in order to enable smoother running and thus a more pleasant run-up for the operator and the machine.

DE 10 2022 127 864 A1 and DE 10 2023 114 869 B3 disclose vibration exciters in which the unbalance forces of a total of four individual exciters arranged in a special way cancel one another out during run-up of the unbalance shafts.

Mutual compensation is not possible with small unbalance exciters, particularly unbalance exciters with only one exciter shaft. Accordingly, if the exciter shaft runs up when unbalanced, there is the problem that the unbalance exciter can enter into a resonance that requires increased motor power. If the drive train is unable to provide this power, the speed of the exciter shaft cannot be increased so that the exciter does not reach its nominal or operating frequency.

To solve this problem, it would be possible to make the drive train (electric motor, cables, frequency converter, battery, etc.) larger, but this would lead to higher costs, larger masses, increased heat generation, or lower efficiency.

### SUMMARY OF THE INVENTION

The invention is based on the object of providing an unbalance exciter with an exciter shaft in which an unbalance effect can be reduced or even largely avoided when the exciter shaft runs up, i.e. when the speed of the exciter shaft is increased, in particular from standstill to the level of the rated speed.

It should be possible to achieve a completely unbalanced run-up until shortly before the rated frequency or rated speed is reached.

The invention is solved by an unbalance exciter having a rotationally driven exciter shaft, a fixed unbalance mass carried by the exciter shaft and fixedly connected to the exciter shaft, and a free unbalance mass carried by the exciter shaft and rotatable on the exciter shaft. The free unbalance mass is held in a defined initial position by a detent device. The free unbalance mass is held in a defined unbalance position by an entrainment device when the free unbalance mass is not held in the initial position by the detent device. The detent device is designed in such a manner that when a predetermined switching speed is exceeded, the detent device is released, and the free unbalance mass is no longer held in the defined initial position by the detent device. In the initial position, an unbalance effect of the free unbalance mass and an unbalance effect of the fixed unbalance mass are directed at least partially in opposite directions. In the unbalance position, the unbalance effect of the free unbalance mass and the unbalance effect of the fixed unbalance mass are at least partially directed in the same direction, i.e., are at least partially aligned.

Accordingly, at least two different types of unbalance masses are mounted on the exciter shaft, namely a fixed unbalance mass and a free unbalance mass. The terms “fixed unbalance mass” and “free unbalance mass” are used here for simplification purposes in order to enable a more comprehensible classification of the two different types of unbalance masses. The fixed unbalance mass is firmly connected to the exciter shaft and, in particular, cannot rotate relative to the exciter shaft. The free unbalance mass, on the other hand, is carried by the exciter shaft, but can rotate relative to the exciter shaft within a certain angular range and can, for example, be mounted on the exciter shaft via a bushing. For example, the free unbalance mass on the exciter shaft can rotate through an angle of 180° relative to the exciter shaft.

In the initial state or idle state, however, the free unbalance mass is held in its position on the exciter shaft (initial position) by the detent device and cannot be rotated on the exciter shaft in this state.

When the speed of the exciter shaft is increased, forces act on the detent device. When the specified switching speed is reached or exceeded, the detent device releases the detent connection between the free unbalance mass and the exciter shaft. As a result, the free unbalance mass is no longer held in its position, namely the defined initial position, on the exciter shaft. Rather, once the switching speed has been exceeded, the free unbalance mass on the exciter shaft is free to rotate within a certain angular range.

As the free unbalance mass rotates relative to the exciter shaft, the relative position of the free unbalance mass to the fixed unbalance mass attached to the exciter shaft also changes. Since both unbalance masses generate unbalance forces or centrifugal forces due to the eccentricity of their centers of mass, a corresponding force resultant of the two unbalance forces of the two unbalance masses also changes.

In the initial position, the two unbalance masses, the free unbalance mass and the fixed unbalance mass, can at least partially be directed in opposite directions with regard to their unbalance effect (centrifugal force). Ideally, they are directed in exactly opposite directions and also have the same strength (magnitude), so that the two opposing centrifugal forces cancel one another out. Completely unbalanced operation is possible in this state. In this state, the centers of gravity of the two unbalance masses can be arranged opposite one another in relation to the axis of rotation of the exciter shaft.

This unbalanced operation can be maintained while the exciter shaft is spinning up until the switching speed is reached. It makes sense to select the switching speed so that it is only just below the nominal speed (nominal frequency) of the exciter shaft, i.e. the speed at which the exciter shaft is to be operated during operation.

If the switching speed is exceeded, the detent connection is released. As described above, the free unbalance mass can rotate relative to the exciter shaft and the fixed unbalance mass. As a result, the unbalance effects are no longer fully or at least partially compensated. This results in an unbalanced effect.

Due to the mass inertia, the free unbalance mass then rotates at a lower speed than the exciter shaft and the fixed unbalance mass. This means that the free unbalance mass is detected relatively quickly, e.g. after a relative swivel of e.g. 180° relative to the exciter shaft, by the entrainment device and is then held in the defined unbalance position. The free unbalance mass can be supported on the entrainment device and is held by the entrainment device during the further rotation of the exciter shaft. If the free unbalance mass has rotated in this way, e.g. by 180° relative to the exciter shaft and the fixed unbalance mass, it is possible that the unbalance effects of the two unbalance masses are aligned in this unbalance position and add up accordingly. In this way, a strong unbalance effect can be achieved if the exciter shaft rotates above the switching speed.

It is not absolutely necessary for the unbalance forces to fully compensate one another in the initial position or for them to be completely opposed. It is also not necessary for the unbalance effects of the two unbalance masses to be exactly aligned in the unbalance position and thus add up completely. In fact, intermediate positions are also possible, which affects the resulting overall force vector of the unbalance effect.

The detent device therefore serves to hold the free unbalance mass in the initial position as long as the exciter shaft has not yet reached the switching speed. When the speed of the exciter shaft increases, a centrifugal force can act on the detent device, which ultimately—when the switching speed is reached—causes the detent device to release, thereby releasing the free unbalance mass. The “detent” and “release” functions of the detent device are therefore determined by the speed or frequency of the exciter shaft. A component of the detent device can serve as a switching element, on which a centrifugal force acts when the exciter shaft rotates.

The entrainment device has the task of capturing the free unbalance mass, which can rotate freely (at least within a certain angular range) due to the released detent device, and holding or supporting it in the defined unbalance position during further rotation of the exciter shaft.

In the initial position, the centrifugal forces acting on the free unbalance mass and the fixed unbalance mass should largely compensate one another, whereas in the unbalance position they should largely add up.

This allows the unbalance exciter to run up to the switching speed, i.e. to just below the rated speed, substantially free of unbalance.

The detent device can have a detent element which, in a state in which the exciter shaft is stationary, is held in a detent position by a spring device, wherein the spring device and the detent element can be designed such that when the specified switching speed of the exciter shaft is exceeded, the detent element is displaced out of the detent position against the action of the spring device such that the detent device is released and no longer holds the free unbalance mass in the defined initial position.

In this embodiment, the detent device thus has the detent element, which is prestressed against the spring device. The detent element can be pressed into a hole formed in the exciter shaft, for example. The hole can then also be understood as part of the detent device.

During rotation, a centrifugal force acts on the detent element. When the switching speed is reached, the centrifugal force is so great that it is sufficient to overcome the spring force of the spring device and move the detent element against the action of the spring device. As a result, the detent element can be moved out of its actual detent position, e.g. out of the hole, and release the detent device.

The detent element can be a detent pin or a bolt or similar. The spring device can be a compression spring or a tension spring, for example.

The spring force generated by the spring device can act against a centrifugal force acting on the detent element when the exciter shaft rotates.

The detent device can be designed in such a manner that it acts between the free unbalance mass and the exciter shaft. This means that the components of the detent device can directly couple the free unbalance mass with the exciter shaft when the free unbalance mass is in the initial position.

The entrainment device can have a stop for the free unbalance mass. This makes it very easy for the free unbalance mass to strike against the stop of the driving device in the transition between the initial position and the unbalance position and to be driven by it.

The entrainment device can act between the fixed unbalance mass and the free unbalance mass. This allows the free unbalance mass to be supported on the fixed unbalance mass with the aid of the entrainment device.

The entrainment device can, for example, have a pin or bolt that extends parallel to the axis of rotation of the exciter shaft. For example, the pin can be held in the fixed unbalance mass and protrude at one end, against which the free unbalance mass can then strike. Ideally, the centrifugal or unbalance forces acting on the two unbalance masses can add up in this position.

Instead of the pin or bolt, the entrainment device can also have a differently designed stop. For example, a suitable stop surface can be formed on the fixed unbalance mass or on the free unbalance mass to ensure that the free unbalance mass is carried along. It is also possible to provide the entrainment device not on the fixed unbalance mass, but on the exciter shaft itself, for example.

In the initial position, the force vectors of the centrifugal forces acting on the free unbalance mass and on the fixed unbalance mass that arise when the exciter shaft rotates can be at an angle in an area of 160° to 200°, i.e. substantially opposite. Ideally, the force vectors are at an angle of 180° so that they can fully compensate for one another. However, this is not absolutely necessary.

The centrifugal forces refer to the respective centers of gravity of the unbalanced masses in terms of magnitude and direction.

In the unbalance position, the force vectors of the centrifugal forces acting on the free unbalance mass and on the fixed unbalance mass can be at an angle in an area of 0° to 40°. The ideal case here would be 0°, so that the force vectors are directed in the same direction and the force effects of the centrifugal forces add up completely. But even this is not absolutely necessary to achieve an improvement in the behavior of the unbalance exciter when starting (revving up the exciter shaft).

An electric drive can be provided to drive the exciter shaft in rotation. The electric drive can, for example, be designed as a direct drive and arranged directly on the exciter shaft. Alternatively, it is possible to couple the electric drive to the exciter shaft via a belt drive or gearing in order to drive the exciter shaft in this manner.

In one embodiment, the electric drive can have an electric motor with a motor shaft, wherein the motor shaft can serve as an exciter shaft and carry the two unbalance masses (free unbalance mass, fixed unbalance mass). In this manner, a very compact design of the unbalance exciter can be realized with minimal weight and only a few components.

The exciter shaft can have two ends, wherein a fixed unbalance mass and a free unbalance mass can be arranged at each end. The exciter shaft therefore carries a total of four unbalance masses, namely two fixed unbalance masses and two free unbalance masses.

It can be advantageous if the two fixed unbalance masses are each attached on the outside, at the end of the exciter shaft, while the two free unbalance masses are arranged further inwards. A reversed arrangement of the two unbalance masses is also possible.

In one arrangement, the two unbalance masses (free unbalance mass, fixed unbalance mass) can be arranged in the center of the exciter shaft.

The electric motor can have a rotor and a stator, wherein the rotor can be arranged on the exciter shaft. In this manner, the rotor can form a unit with the exciter shaft or be attached directly to the exciter shaft. This design makes it easier to arrange the electric motor centrally on the exciter shaft, which can be advantageous for symmetrical operation of the unbalance exciter.

In one variant, several exciter shafts can be provided, each of which can carry at least one fixed unbalance mass and one free unbalance mass, wherein a detent device and a driving device can be provided for each free unbalance mass in the manner described above.

In this manner, the unbalance exciter can have any number of exciter shafts, wherein each exciter shaft can rotate up from standstill to the nominal frequency substantially unbalance-free. The exciter shafts can be coupled together via gear wheels or driven individually by electric motors.

When the unbalance exciter (or the vibration plate using the unbalance exciter) is switched off, the unbalance exciter and the exciter shaft coast, which, when the switching speed is undershot, causes the free unbalance mass to rotate back to the initial position and the detent device to re-establish a connection between the free unbalance mass and the exciter shaft. This is useful so that the unbalance exciter is prepared for the next start, when the two unbalance masses should act in opposite directions to enable the exciter to run up with as little unbalance as possible.

However, this requires the two unbalance masses to be brought back into the initial position relative to each other, e.g. in the starting position rotated by 180°. A machine control unit can be provided for this purpose, which can be designed to perform at least one of the following functions on command from an operator or automatically when the unbalance exciter is switched off:

Braking of the electric motor with at least a predetermined deceleration and, if necessary, switching off the unbalance exciter and bringing the exciter shaft to a standstill;

Once the exciter shaft has come to a standstill, slowly rotating the exciter shaft by at least 180° in the opposite direction to its running direction;

Once the exciter shaft has come to a standstill, suddenly rotating the exciter shaft by at least 180° in the opposite direction to its running direction.

The running direction is to be understood here as the normal running direction or rotational direction of the exciter shaft during operation of the unbalance exciter. The design of the entrainment device, for example, also depends on the “normal” running direction, as it should be particularly effective when the exciter shaft rotates in the normal running direction.

The options described above for using the machine control system to switch off the unbalance exciter and realign the two unbalance masses are described in more detail below.

In the first alternative with the function “braking the electric motor with at least one predefined deceleration”, the exciter shaft can be actively braked by the electric motor when the unbalance exciter runs out. If the deceleration is sufficiently large, the free unbalance mass overtakes the exciter shaft with the fixed unbalance mass. The detent device, e.g. the detent pin of the detent device, can then find the bore of the exciter shaft again, so that the initial state with the free unbalance mass in the initial position can be reached again. A new unbalanced run-up is prepared for the next start. The machine controller can then switch off the vibration plate for good.

In the second alternative of the switch-off functions, the exciter shaft is first brought to a standstill or can coast to a standstill. Both unbalance masses can then hang down. The exciter shaft is then slowly rotated by the electric motor by at least 180° in the opposite direction to its running direction. This moves the fixed unbalance mass upwards, while the free unbalance mass continues to hang downwards. Provided that the detent connection is made using a detent pin and the frictional force of the detent pin on the exciter shaft is small enough, the detent pin can reach the hole on the exciter shaft again and engage in it. The free unbalance mass is in the initial position. The machine controller then switches the vibration plate off for good.

With the third alternative of the switch-off functions, the exciter shaft can also come to a standstill first. Both unbalance masses can then hang downwards. The exciter shaft is then rotated jerkily by the electric motor by at least 180° in the opposite direction to its running direction. The high acceleration and the inertia of the free unbalance mass exceed the frictional force of the detent pin on the exciter shaft, so that the detent pin can now re-engage in the bore on the shaft. The machine controller can then switch off the vibration plate for good.

The invention enables not only an unbalance-reduced, but—depending on the design—completely unbalance-free run-up of an unbalance exciter.

Due to the unbalanced run-up, no resonance frequencies are passed through that would make the run-up more difficult. This means that the entire drivetrain can be designed to be weaker, keeping masses, costs, and component temperatures low. At the same time, the efficiency can be increased or the runtime of a battery (accumulator) for the electric motor can be extended. The design also makes it possible to reduce the run-up time because the electric motor requires less power to pass through resonance frequencies. In addition, start-up is quieter and less vibrating. The rattling of components that resonate below the nominal frequency can be avoided.

The controller can be configured simply. No complex control technology is required. In addition, the unbalance exciter according to the invention can be applied to any number and arrangement of exciters on a lower mass.

The unbalance exciter according to the invention can be used in particular in a vibration plate for soil compaction. A vibration plate of this type can have an upper mass and a lower mass, wherein the upper mass is decoupled from the lower mass by means of a vibration decoupling device, e.g. rubber buffers. An energy storage, e.g. a battery, can be provided on the upper mass. It is also possible to attach a guide bracket to the upper mass, which an operator can use to guide the vibration plate.

The lower mass has a floor contact plate on which the unbalance exciter belonging to the lower mass can be mounted. In this manner, the vibrations generated by the unbalance exciter can be introduced directly into the soil to be compacted via the ground contact plate.

### BRIEF DESCRIPTION OF THE DRAWINGS

The invention is explained in more detail below by means of examples with the aid of the accompanying figures. In the drawings:

FIG. 1 is a schematic representation of the structure of a vibration plate;

FIG. 2 is a schematic sectional view of the structure of an unbalance exciter according to the invention;

FIG. 3 is a shaft end of an exciter shaft in perspective view, with unbalance masses in the initial position;

FIG. 4 is the arrangement of FIG. 3 in a partially sectioned front view;

FIG. 5 is a perspective view of the shaft end of the exciter shaft, with unbalance masses in the unbalance position;

FIG. 6 is the arrangement of FIG. 5 in a partially sectioned front view;

FIG. 7 is the position of the unbalance masses after switching off the unbalance exciter, but before reaching the initial position (start position); and

FIG. 8 is the position of the unbalance masses after performing a switch-off function.

### DETAILED DESCRIPTION

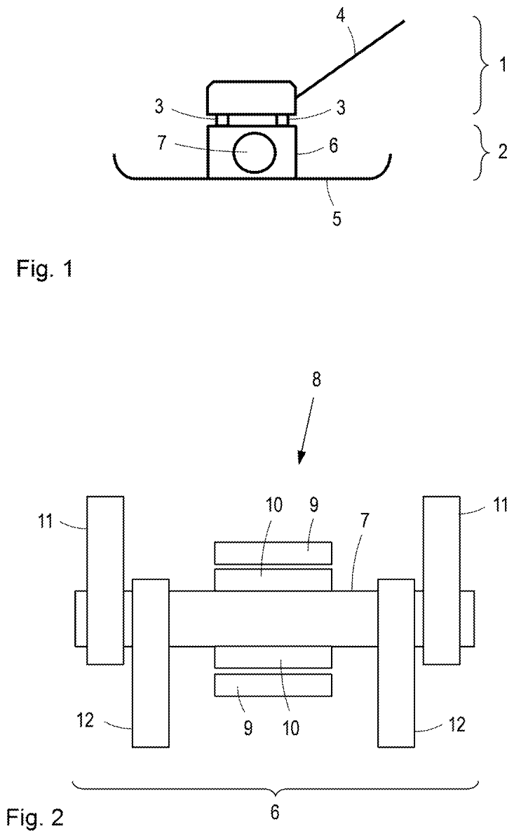

FIG. 1 shows a schematic structure of a known vibration plate for ground compaction, in which the unbalance exciter according to the invention can be used.

The vibration plate has an upper mass 1 and a lower mass 2, which are connected in a vibration-decoupled manner by a vibration decoupling device 3, e.g. with several rubber buffers.

The upper mass 1 can, for example, have a battery (accumulator) with which an electric motor provided on the upper mass 1 or on the lower mass 2 can be supplied. In the example shown, a guide drawbar 4 is also attached to the upper mass 1, with the help of which an operator can guide the vibration plate.

A ground contact plate 5 is provided on the lower mass 2, with which the ground to be compacted can be compacted. An unbalance exciter 6 (sometimes referred to simply as an exciter) is arranged on the contact plate 5. The unbalance exciter 6 has an exciter shaft 7.

FIG. 2 shows a schematic section through the unbalance exciter 6.

An electric motor 8 is arranged on the exciter shaft 7, with a stator 9 and a rotor 10. The rotor 10 is mounted in the center of the exciter shaft 7 directly on the exciter shaft 7. This enables a very compact design of electric motor 8 and exciter shaft 7. Of course, other variants are also possible to set the exciter shaft 7 in rotation.

Two unbalance masses are arranged at each end of the exciter shaft 7: a fixed unbalance mass 11 and a free unbalance mass 12. The fixed unbalance mass 11 can be firmly bolted to the exciter shaft 7, for example. It cannot be moved relative to the exciter shaft 7; in particular, it cannot be rotated.

The free unbalance mass 12, on the other hand, can be pivoted—at least within certain angular limits—relative to the exciter shaft 7 and thus also to the fixed unbalance mass 11.

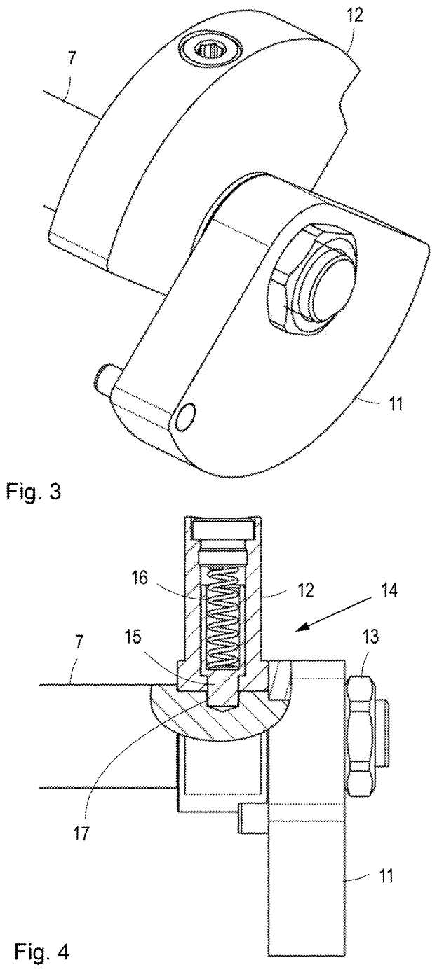

FIGS. 3 and 4 show the shaft end of the exciter shaft 7 in greater detail.

The fixed unbalance mass 11 is firmly screwed onto the exciter shaft 7 with the aid of a nut 13.

A detent device 14 is provided inside the free unbalance mass 12, with a detent pin 15 serving as a detent element, which is acted upon by a compression spring 16 and pressed into a bore 17 in the exciter shaft 7. In this manner, in the initial position shown in FIGS. 3 and 4, the free unbalance mass 12 is fixed in a form-locking manner on the exciter shaft 7 with the help of the detent device 14. The detent pin 15 ensures form-locking between the free unbalance mass 12 and the exciter shaft 7.

The two unbalance masses 11, 12 are arranged rotated by 180° relative to one another. With an appropriate design, this can ensure that the centrifugal forces (unbalanced forces) generated when the exciter shaft 7 rotates are fully compensated. This ensures that no imbalance effect occurs when accelerating the exciter shaft 7. This enables the exciter shaft 7 to spin up smoothly and evenly.

When the speed of the exciter shaft 7 is increased from the initial position of the unbalance masses 11, 12 shown in FIGS. 3 and 4, a centrifugal force acts on the detent pin 15 due to the eccentric position of the detent pin 15 in relation to the axis of rotation of the exciter shaft 7. The centrifugal force acts against the compressive force of the compression spring 16. When the speed of the exciter shaft 7 is high enough, the detent pin 15 moves out of the bore 17 so that the detent connection is released and the free unbalance mass 12 is released.

The speed at which the detent connection of the detent device 14 is released is also known as the switching speed. Ideally, it should be just below the actual rated speed at which the exciter is to be operated.

Due to the mass inertia, the free unbalance mass 12, which is no longer held by the detent device 14, follows the exciter shaft 7 and the fixed unbalance mass 11 and thus rotates relative to them.

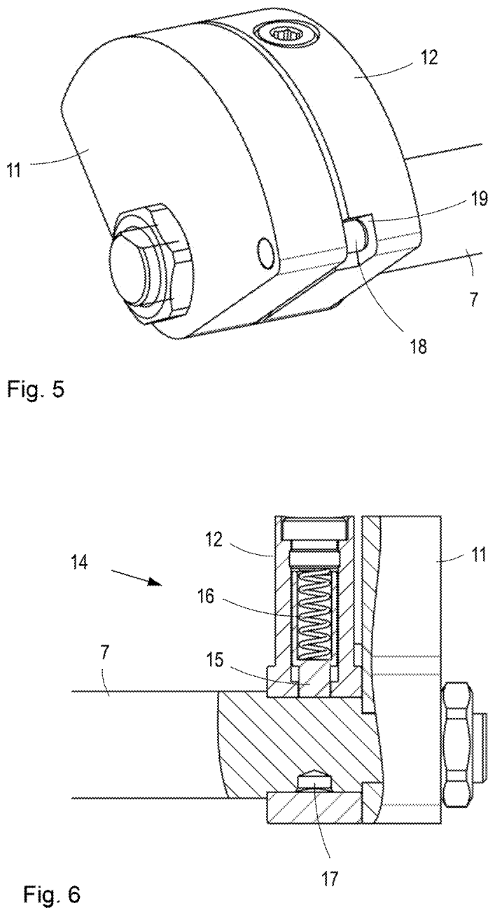

This finally achieves the unbalance position shown in FIG. 5, in which the two unbalance masses 11, 12 are arranged on the same side, so that the centrifugal forces of the two unbalance masses 11, 12 add up.

When the free unbalance mass 12 has rotated by e.g. 180° relative to the exciter shaft 7 and the fixed unbalance mass 11, a pin 18 serving as a driving device engages in a recess 19 in the free unbalance mass 12. The pin 18 is attached to the fixed unbalance mass 11.

This ensures that the free unbalance mass 12 strikes against a stop in the form of the pin 18 and can then no longer rotate any further relative to the exciter shaft 7 and the fixed unbalance mass 11. If the unbalance masses 11, 12 are designed accordingly, the two centrifugal forces can be completely added together. In this state, the unbalance exciter can develop its full unbalance effect.

FIG. 6 shows a partial section of the state of the detent device 14 in the unbalanced position of FIG. 5. The detent pin 15 is disengaged from the hole 17 against the action of the compression spring 16.

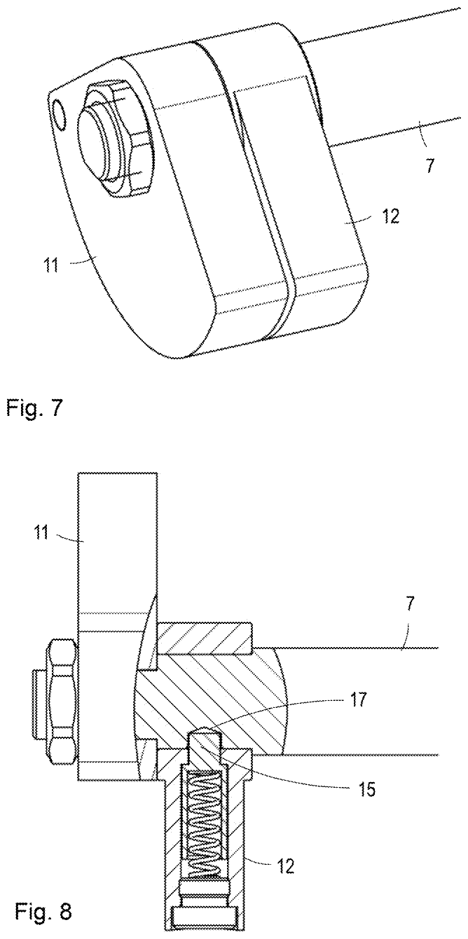

FIG. 7 shows an end position of the exciter shaft 7 with the two unbalance masses 11, 12, after switching off the unbalance exciter or the electric motor 8. Both unbalance masses 11, 12 hang downwards. There is no detent connection between the free unbalance mass 12 and the exciter shaft 7.

The machine controller can be designed to slowly rotate the exciter shaft 7 against the running direction (normal direction of rotation during operation) so that the fixed unbalance mass 11 is rotated upwards without taking the free unbalance mass 12 with it via the pin 18 serving as an entrainment device. The free unbalance mass 12 thus continues to hang downwards until finally, after a rotation of 180°, the locking pin 15 can engage in the hole 17 again, thereby re-establishing the locking connection, as FIG. 8 shows.

This shutdown process is one of several variants. In another variant (not shown), the electric motor can be actively braked with a certain delay after receiving a switch-off command from the operator (e.g. switching off the machine). This allows the free unbalance mass 12—with a correspondingly large delay—to overtake the exciter shaft 7 and the fixed unbalance mass 11 and return to the detent position as shown in FIG. 8.

In another variant—starting from the position of the two unbalance masses 11, 12 shown in FIG. 7—the exciter shaft 7 can be rotated jerkily by at least 180° in the opposite direction to its running direction. Due to the high acceleration and the inertia of the free unbalance mass 12, the frictional force of the detent pin on the exciter shaft 7 can be overcome and the initial position shown in FIG. 8 can be reached. This takes into account that the detent pin 15 may be pressed onto the exciter shaft 7 with high pressure by the compression spring 16, as shown in FIG. 6, which leads to a large frictional force between the end face of the detent pin 15 and the surface of the exciter shaft 7.

The position shown in FIG. 8 corresponds to the initial position shown in FIG. 4, but only rotated by 180° in the illustration.

1. An unbalance exciter comprising:
a rotationally driven exciter shaft;
a fixed unbalance mass which is carried by the exciter shaft and which is firmly connected to the exciter shaft;
a free unbalance mass which is carried by the exciter shaft and which is rotatable on the exciter shaft;
wherein
the free unbalance mass is held in a defined initial position by a detent device ;
the free unbalance mass is held in a defined unbalance position by an entrainment device if the free unbalance mass is not held in the initial position by the detent device;
the detent device is designed in such a manner that, when a predetermined switching speed is exceeded, the detent device is released and the free unbalance mass is no longer held in the defined initial position by the detent device;
in the initial position, an unbalance effect of the free unbalance mass and an unbalance effect of the fixed unbalance mass are directed at least partially in opposite directions; and wherein
in the unbalance position, the unbalance effect of the free unbalance mass and the unbalance effect of the fixed unbalance mass are at least partially aligned.

2. The unbalance exciter according to claim 1, wherein
the detent device has a detent element which, in a state in which the exciter shaft is stationary, is held in a detent position by a spring device; and wherein
the spring device and the detent element are designed in such a manner that, when the predetermined switching speed of the exciter shaft is exceeded, the detent element is displaced out of the detent position against the action of the spring device in such a manner that the detent device is released and no longer holds the free unbalance mass in the defined initial position.

3. The unbalance exciter according to claim 1, wherein the detent device acts between the free unbalance mass and the exciter shaft.

4. The unbalance exciter according to claim 1, wherein the entrainment device comprises a stop for the free unbalance mass.

5. The unbalance exciter according to claim 1, wherein the entrainment device acts between the fixed unbalance mass and the free unbalance mass.

6. The unbalance exciter according to claim 1, wherein, in the initial position, force vectors of the centrifugal forces acting on the free unbalance mass and on the fixed unbalance mass are separated by an angle of 160° to 200°.

7. The unbalance exciter according to claim 1, wherein, in the unbalance position, force vectors of the centrifugal forces acting on the free unbalance mass and on the fixed unbalance mass are separated by an angle of 0° to 40°.

8. The unbalance exciter according to claim 1, further comprising an electric drive for rotatingly driving the exciter shaft.

9. The unbalance exciter according to claim 8, wherein
the electric drive comprises an electric motor with a motor shaft, and wherein
the motor shaft serves as the exciter shaft and carries the two unbalance masses.

10. The unbalance exciter according to claim 1, wherein
the exciter shaft has two ends; and wherein
a fixed unbalance mass and a free unbalance mass are arranged at each end of the fixed unbalance mass.

11. The unbalance exciter according to claim 8, wherein
the electric motor comprises a rotor and a stator; and wherein
the rotor is arranged on the exciter shaft.

12. The unbalance exciter according to claim 1, wherein
several exciter shafts are provided, each carrying at least one fixed unbalance mass and one free unbalance mass; and wherein
a detent device and an entrainment device are provided for each free unbalanced mass.

13. The unbalance exciter according to claim 1, further comprising a machine controller which is designed to effect at least one of the following functions when the unbalance exciter is switched off:
braking of the electric motor with at least one predetermined deceleration;
after the exciter shaft has come to a standstill, slow rotating of the exciter shaft through an angle of at least 180° in the opposite direction to its running direction;
after the exciter shaft has come to a standstill, jerkily rotating of the exciter shaft by at least 180° in the opposite direction to its running direction.
